(19) United States
(12) Patent Application Publication
(10) Pub. No.: US 2008/0086431 A1
(43) Pub. Date: Apr. 10, 2008

(54) SOCIAL INTERACTION MESSAGING AND NOTIFICATION

(75) Inventors: Merle Michael Robinson, Redmond, WA (US); Eric James Hennings, Seattle, WA (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: ICEBREAKER, INC., (US)

(21) Appl. No.: 11/855,918

(22) Filed: Sep. 14, 2007

Related U.S. Application Data
(60) Provisional application No. 60/825,851, filed on Sep. 15, 2006.

(51) Int. Cl. G06F 17/18; G06F 15/16

(52) U.S. Cl. 706/11; 709/206

(57) ABSTRACT

A system (and method) that enables and administers notifications and messages within a social networking service is provided. The system can prompt notification in a number of scenarios including, but not limited to, when a user expresses interest in another user, when new messages arrive, when unread messages are available, etc. Additionally, the innovation enables messages to be communicated upon a detection of a mutual interest between two users or members. Further, messages can be presented to a user in most any desired manner, e.g., ranked, ordered, etc.

### CROSS-REFERENCE TO RELATED APPLICATIONS

This application claims the benefit of U.S. Provisional Patent application Ser. No. 60/825,851 entitled “MOBILE SOCIAL NETWORK”, filed on Sep. 15, 2006 and is related to Ser. No. entitled “SOCIAL INTERACTION SYSTEM”, filed on Jul. 10, 2006, and to U.S. patent application Ser. No. ______ entitled ‘SOCIAL INTERACTION GAMES AND ACTIVITIES’, filed on ______, and to U.S. patent application Ser. No. ______ entitled ‘SOCIAL INTERACTION TAGGING’, filed on ______, and to U.S. patent application Ser. No. ______, entitled ‘LOCATION-BASED SOCIAL INTERACTION NETWORK’, filed on, and to U.S. patent application Ser. No. ______ entitled ‘DATE MANAGEMENT WITHIN A SOCIAL INTERACTION NETWORK’, filed on ______. The entireties of the above-noted applications are incorporated by reference herein.

### BACKGROUND

The Internet continues to make available ever-increasing amounts of information which can be stored in databases and accessed therefrom. Additionally, with the proliferation of portable terminals (e.g., notebook computers, cellular telephones, personal data assistants (PDAs), smart-phones and other similar communication devices), users are becoming more mobile, and hence, more reliant upon information accessible via the Internet. Accordingly, the connectivity available via the Internet is frequently used to chat, socialize and communicate with friends and family.

One particular area in which the Internet is becoming popular is in the field of Internet dating and other social interaction services generally. An Internet dating service, or online dating, allows people to meet and get acquainted online thereafter potentially engaging in a romantic relationship. Conventional dating services are oftentimes moderated by a third party who matches candidates based upon criteria and/or preferences.

These online dating services enable a user to create a profile which can contain information relating to physical as well as personal characteristics. As well, these online dating services enable a user to search profiles of other candidates in order to locate a match based upon a predetermined set of criterion. For example, a user can search upon physical characteristics such as age, height, weight, hair color, etc. As well, personal characteristics such as income, interests, hobbies, religion, etc. can be used to search profiles.

Online dating or Internet dating continues to expand in popularity as more and more people become acquainted with the Internet and its vast communication resources. Effectively, the seemingly anonymity of the Internet alleviates much of the apprehension and pressures associated with face-to-face communication felt by many individuals.

Online dating or internet dating services enable people to meet online and possibly develop a friendship, a romantic or even sexual relationship. These online dating services enable individuals to provide personal information, for example, age, gender and location. Accordingly, the services promote others to search these individuals using the profile criteria. As well, many dating services allow members to include a photo in their profile which can be searched by others.

In general, online dating services operate by the same criteria as typical relationships. However, factors specific to the nature of online communications may affect the experience. There are many positive factors that can inherently enhance the online experience. For example, online dating sites facilitate individuals to meet more people than they would without such sites. As well, online matchmaking sites enable individuals to easily browse other members' profiles before deciding to initiate communication.

Essentially, these online dating services enable users to break down geographic barriers while enabling users or members to learn more about a prospect or candidate before actually expending the time and effort to pursue a meeting. In today's busy society, the value added by the ability to pre-screen candidates is very desirable.

Conventional dating services have begun to migrate into today's mobile society. More particularly, recent developments have been directed to employing matchmaking services via mobile devices such as cell phones, smart-phones, etc. However, because these conventional mobile systems are nothing more than a mobile version of the traditional Internet dating systems, they have been plagued with slow response time, widespread deception and lack of interactivity.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems (and corresponding methods) that enable management of notifications and messages within a social networking service. More particularly, the innovation can trigger notification in a number of scenarios including, but not limited to, when a user expresses interest in another user, when new messages arrive, when unread messages are available, etc. In aspects, messages can be communicated upon a detection of a mutual interest between two users or members.

In still other aspects, a user can set specifics related to notifications (or alerts) as well as messages. For example, a user can select parameters such as, what modality to employ, when to deliver, when not to deliver, what device to select, etc. Essentially, most any parameter can be personalized in disparate aspects.

Still further, the innovation enables configuration of notification and/or messages in accordance with user preferences. Additionally, alerts and messages can be sorted, filtered, ranked or ordered in accordance with most any factor, e.g., timing, preference, subject, location, etc.

In yet another aspect thereof, contextual awareness and/or machine learning & reasoning (MLR) components are provided that employ a probabilistic and/or statistical-based analysis to infer an action that a user desires to be automatically performed. For example, MLR can be employed to automatically select candidates and/or schedule a meeting.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates notification and messaging in a social matching environment in accordance with an aspect of the innovation.

FIG. 2 illustrates an example communication exchange between two wireless devices in accordance with the subject matter of the innovation.

FIG. 3 illustrates an example flow chart of procedures that facilitate messaging in a mutual crush scenario in accordance with an aspect of the innovation.

FIG. 4 illustrates an example flow chart of procedures that facilitate employment of personalization factors in accordance with an aspect of the innovation.

FIG. 5 illustrates an example block diagram of a communication system that enables personalization in accordance with an aspect of the innovation.

FIG. 6 illustrates an example block diagram of an alternative communication system that facilitates alert and message generation in accordance with an aspect of the innovation.

FIG. 7 illustrates an alternative communication system that facilitates anonymous audio, video, picture and/or text communication in accordance with an aspect of the innovation.

FIG. 8 illustrates an example communication system diagram that employs contextual awareness and/or machine learning & reasoning logic to automate one or more features of the innovation.

FIG. 9 is a schematic block diagram of an example portable handheld device according to one aspect of the subject innovation.

FIG. 10 illustrates an example screen shot of a social interaction home screen in accordance with an aspect of the innovation.

FIG. 11 illustrates an example screen shot of a social interaction home browsing screen (without a display skin) in accordance with an aspect of the innovation.

FIG. 12 illustrates an example screen shot of a social interaction home browsing screen (with a display skin) in accordance with an aspect of the innovation.

FIG. 13 illustrates an example screen shot of a social interaction find and filter configuration screen in accordance with an aspect of the innovation.

FIG. 14 illustrates an example screen shot of a social interaction out-of-range crush notification screen in accordance with an aspect of the innovation.

FIG. 15 illustrates an example screen shot of a social interaction in-range crush notification (without details) screen in accordance with an aspect of the innovation.

FIG. 16 illustrates an example screen shot of a social interaction in-range crush notification (with details) screen in accordance with an aspect of the innovation.

FIG. 17 illustrates an example screen shot of a social interaction settings home screen in accordance with an aspect of the innovation.

FIG. 18 illustrates an example screen shot of a social interaction alert settings home screen in accordance with an aspect of the innovation.

FIG. 19 illustrates an example screen shot of a social interaction alert protocol selection screen in accordance with an aspect of the innovation.

FIG. 20 illustrates an example screen shot of a social interaction alert scheduling screen in accordance with an aspect of the innovation.

FIG. 21 illustrates an example screen shot of a social interaction messages home screen in accordance with an aspect of the innovation.

FIG. 22 illustrates an example screen shot of a social interaction messages list screen in accordance with an aspect of the innovation.

FIG. 23 illustrates an example screen shot of a social interaction message response screen in accordance with an aspect of the innovation.

FIG. 24 illustrates a block diagram of a computer operable to execute the disclosed notification and messenging architecture.

FIG. 25 illustrates a schematic block diagram of an example computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures as screenshots, those skilled in the relevant art will recognize that various other alternatives can be employed. The terms “screen,” “display,” “web page,” and “page” are generally used interchangeably herein. The pages or screens are stored and/or transmitted as display descriptions, as graphical user interfaces, or by other methods of depicting information on a screen (whether personal computer, mobile telephone, or other suitable device, for example) where the layout and information or content to be displayed on the page is stored in memory, database, or another storage facility. Similarly, the information can be dynamically modified in accordance with a particular device as available or desired.

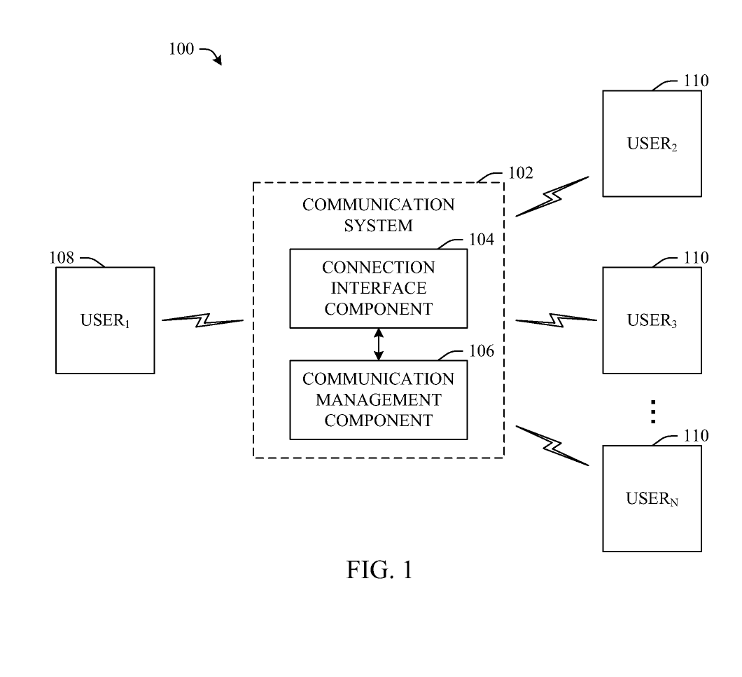

Referring initially to FIG. 1, the subject innovation is directed to a system 100 (and associated methods) that facilitates messaging and/or notification functionalities of a social interaction system. As illustrated, the system 100 can include a communication system 102 having a connection interface 104 and a communication management component 106. Together, these components manage and enable messaging and notification between a users or members 108, 110 within a network. In accordance therewith, these components enable voice, video, picture, text communications to be delivered between users/members (108, 110). Essentially, a first user 108 can communicate (e.g., prompt messages, receive notifications) to/from other users 110 within the network via the communication system 102.

The connection interface 104 enables many of the core functionalities of a social interaction service. For instance, the connection interface 104 can maintain user/member profiles, contact information, preferences, policies, etc. In other words, the connection interface 104 can provide mechanisms and means for users to locate each other by browsing personal characteristics, interests, locations, preferences, etc. of other users, members or subscribers.

In addition to providing the core social networking functionality, the connection interface 104 can also provide query, search and filter capabilities. These additional capabilities enable members to be logically matched based upon similarities, preferences, policies or the like. As will be described below, most any functionality of the system 100 (including the connection interface), can be enhanced by the use of sophisticated logic mechanisms such as machine learning & reasoning (MLR) logic mechanisms. In these examples, the system 100 can learn, e.g., based upon statistics, history, feedback, etc., and can automatically act on behalf of a user.

System 100 provides a fun, easy and sophisticated way to connect people, chat, and stay in contact by way of a personal computer (PC), mobile device (e.g., smart-phone) or other suitable device. The connection interface 104 enables people to be located by browsing (or searching) by gender, age, location, interest, as well as other informational tags. Once a user finds someone of interest, they can select that person thereby prompting the connection. Here, the communication management component 106 can notify the located person of the user's interest. Once the interest is reciprocated, the communication management component 106 can notify each person of the mutual interest. Thereafter, communication can be enabled via the communication system 102.

While many examples are described herein, it is to be understood and appreciated that other examples of messaging and notification scenarios exist—which are to be considered within the scope of this innovation. By way of specific example, while text messaging via a cellular phone or smart-phone is described, other means of communicating are to be included within the scope of the disclosure and claims appended hereto. For instance, examples that employ instant messaging (IM), Voice-Over-IP (Internet Protocol) (VoIP), or the like are to be included within the innovation described herein.

By way of further example, the messaging and notification mechanisms described herein can be employed to effectuate social interaction games that include communication via voice, video, picture, text or any combination thereof. For example, notifications can be provided to inform a user of actions taken during game play (e.g., ‘it's your turn’).

The scenarios included herein are directed to a social interaction services, e.g., networking, matchmaking scenarios. While many of the uses of this technology are directed to social interaction services, it is to be understood and appreciated that the features, functions and benefits of the innovation (e.g., messaging and communications services) can be employed in connection with most any scenario where a service is employed to connect parties. By way of example, the systems and functionality of the innovation can be employed in scenarios including, but not limited to, social support, help-lines, support and treatment scenarios.

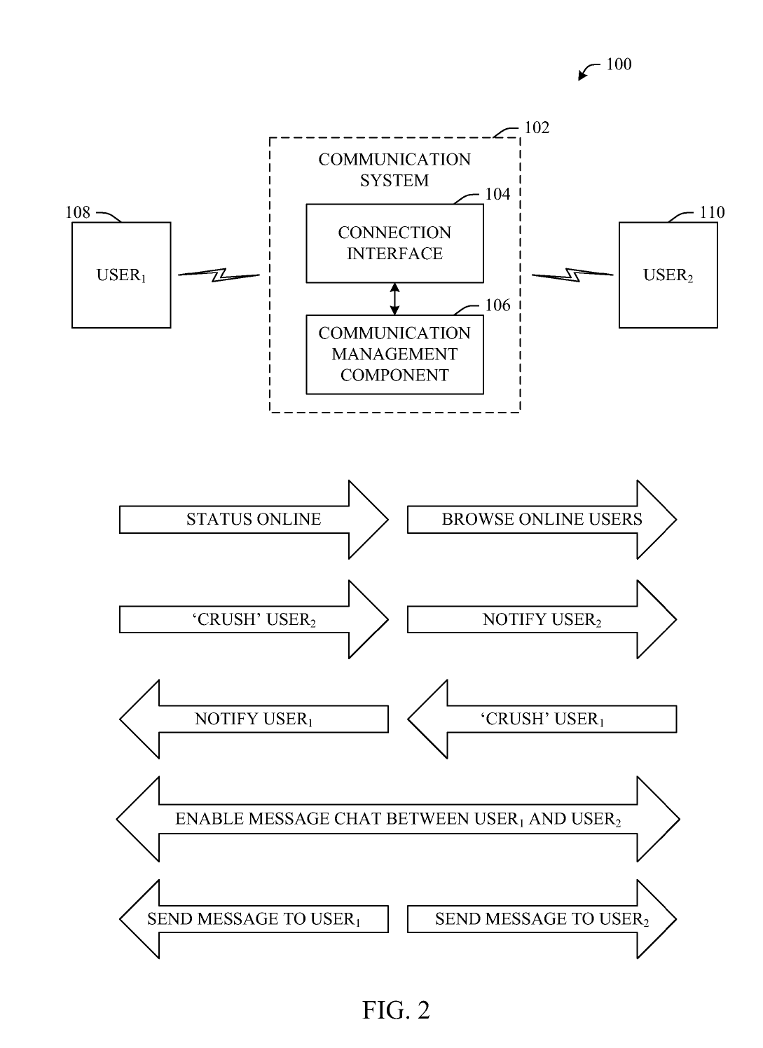

Turning now to FIG. 2, an example communication exchange between two wireless device users (108, 110) in accordance an aspect of the innovation is shown. As described above, although this exchange is directed to an exchange between two users (108, 110), it is to be understood that the exchange can be employed in connection with most any number of users in alternative aspects. To this end, it will be understood that the messaging and/or notification services described herein can be employed in connection with most any network of users.

Moreover, it will be understood that virtually any wireless communication devices can be employed in connection with alternative aspects. By way of example and not limitation, the wireless devices (108, 110) shown can be cell phones, smart-phones, personal data assistants (PDAs), laptops, PCs, palm-top computers, or the like. Although the scenarios described herein are directed to employing the novel functionality in connection with “wireless” devices, it will be understood that other wired devices can also employ the novel functionality described herein. By way of example and not limitation, the innovation can be employed to initiate, transfer or forward a message or notification to a conventional landline of choice.

As shown in FIG. 2, a first wireless device user (e.g., 108) can launch a service and initiate an online status by way of the communication system component 102. As will be described herein, the user can launch a social interaction service or application. Once the social interaction service is launched, the user can browse profiles associated with online users. In the scenario of a social interaction service, the first wireless device user (e.g., 108) can be used to browse online or offline candidates.

In accordance with the scenario of FIG. 2, the first user can select (or ‘crush’) a second user (e.g., 110). In one specific embodiment, a ‘crush’ can be used synonymously to ‘select’ or to express an interest in another user. Conversely, a ‘flush’ can be used synonymously with ‘pass’ or to illustrate lack of interest in another user. Here, as shown, a first user can ‘crush’ a second user.

Accordingly, a notification can be sent to the second user to notify them of the first user ‘crush’ or selection. As will be understood, the notification can be sent by most any desired means known in the art, including but not limited to, text message, picture message, email, IM, audible alert, video alert, etc. As well, it will be appreciated that the means of notification can be personalized by a receiving party. For example, a user can opt to receive notifications by way of text message only between the hours of 1:00 pm and 5:00 pm EST. Still further, the notification can further be personalized by the ‘crushing’ party such that the message received conveys a desired message content, e.g., via voice message, video message, picture message, text message or the like.

Once a notification is received, the second user can be given the opportunity to ‘crush’ or ‘flush’ the party. In the example of FIG. 2, suppose the second party opts to ‘crush’ the first party. As indicated with reference to the first notification, a notification can be sent to the first party that indicates a mutual desire to connect, e.g., ‘mutual-crush.’ As described above, it is to be understood that this notification can include most any information and be conveyed by way of most any protocol without departing from the scope of this innovation.

Once a ‘mutual-crush’ is consummated, the system (e.g., communication system 102 of FIG. 1) can enable message chat between the users. As described in the Related Application set forth above, this communication can be anonymous as desired. Alternatively, the contact information of the parties can be made known as desired. The message flow of FIG. 2 illustrates an anonymous communication scenario where the messages are sent to each individual party by way of the communication system thereby securing contact information (e.g., email address, text messaging alias, phone numbers, etc.). Still further, if desired, avatars or the like can be personalized and employed to project a more real-life feel without revealing true identity of either party.

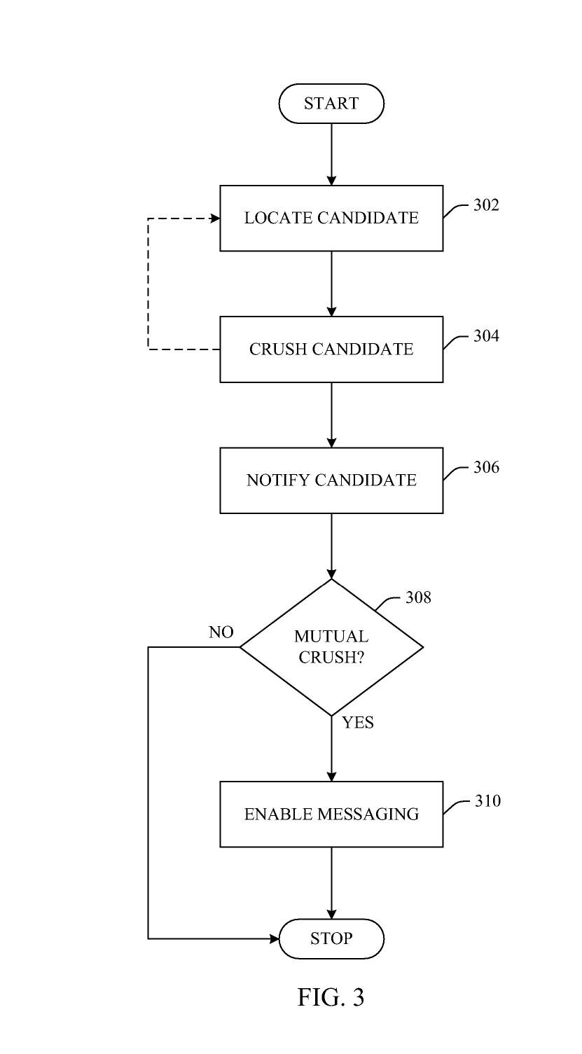

FIG. 3 illustrates a methodology of messaging and notification with respect to a social interaction application in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 302, a candidate can be located via the service of a social interactive system or other social application. Once a candidate (or group of candidates) is identified, the locating party can choose to ‘crush’ or ‘flush’ the candidate. In other words, the user can select or defer selection (e.g., pass) of the party. In the example of FIG. 3, the candidate is crushed (or selected) at 304. Alternative, if the candidate was flushed, or if additional candidates are desired, the user can continue to locate other candidates at 302, as illustrated by the dashed line in FIG. 3.

Once crushed, the crushed candidate can be notified of the selection at 306. Here, this notification can be made by way of IM, picture message, text message, email, or other audible, visual or text alert as desired. A determination is made to identify if a mutual crush has been effected. If not, the methodology ends. However, if a mutual crush is established at 308, messaging between the parties is enabled at 310.

As with the notifications, it is to be understood that most any protocol can be employed with regard to messaging between the parties. For instance, IM, text message, picture message, email, etc. can be employed to accomplish communication between the parties. Still further, it is to be understood that the messaging at 310 (as well as the notifications at 306) can be communicated by way of voice, video, picture, text or combinations thereof.

Additionally, notifications and/or messages can be managed in accordance with a predefined policy and/or preference. For example, a user can define a protocol as well as acceptable/preferred times, dates, contexts, etc. by which to control delivery of notifications and/or messages. By way of specific example, rules can be defined that regulate delivery between certain hours of the day or days of the week as well as with respect to specific activities or context. For instance, the system can determine (e.g., via contextual awareness) a user's location, engaged activity, individuals in proximity, etc. and thereby determine if a notification and/or message should be sent. In other examples, messages and/or notifications can be pre-scheduled in accordance with policies, preference or rules.

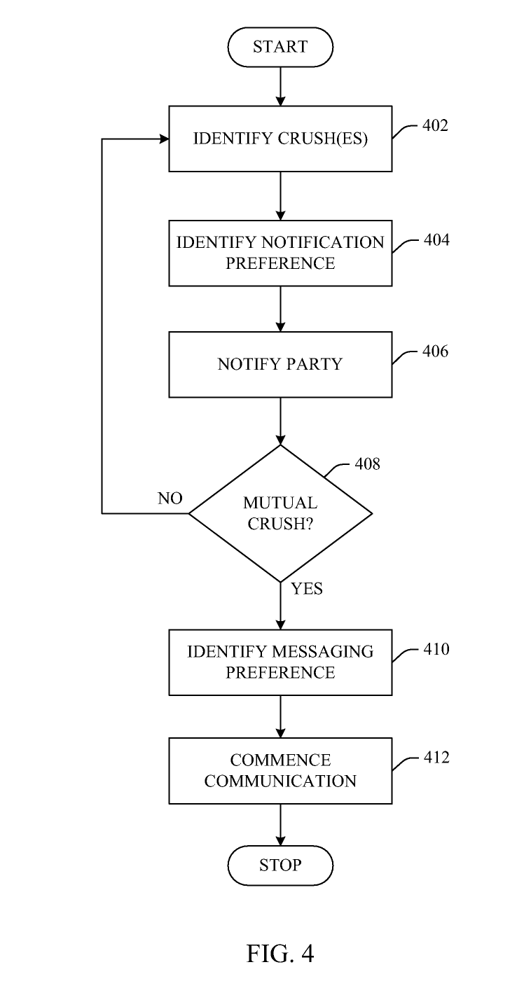

FIG. 4 illustrates a methodology of the employing a policy, preference and/or rule with respect to messaging/notification in accordance with an aspect of the innovation. At 402, a crush can be identified with respect to a party. At 404, a notification preference can be identified. For instance, as described above, the preference can define a protocol as well as delivery parameters associated with a particular protocol.

The crushed party can be notified at 406 and a determination of a mutual crush can be made at 408. If no mutual crush is identified, the process flow can return to 402 to identify crushes. However, if a mutual crush is identified, at 410, messaging preferences can be identified. For example, protocols, parameters, etc. can be identified and employed at 412 to commence communications.

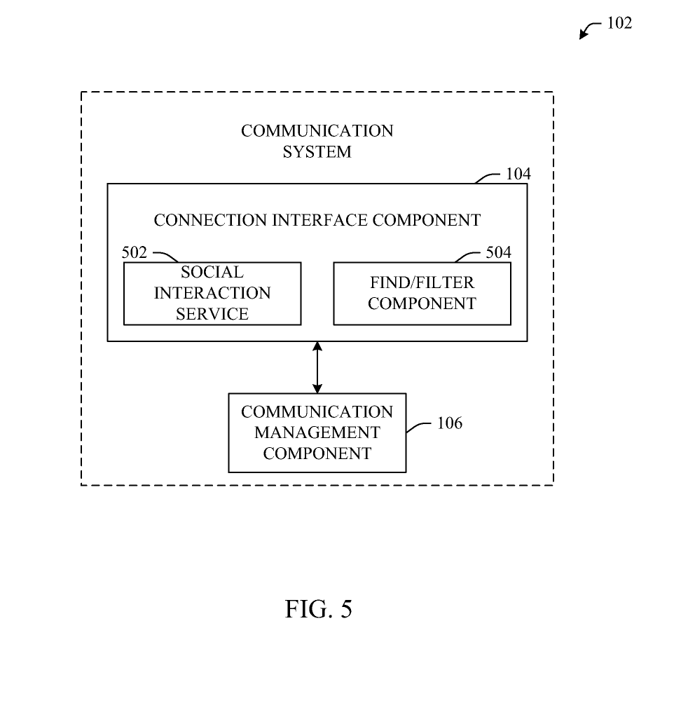

Turning now to FIG. 5, an alternative block diagram of communication system 102 is shown. As described with reference to FIG. 1, the communication system 102 can include a connection interface component 104 and communication management component 106. As shown in FIG. 5, the connection interface component 104 can include a social interaction service 502 and a find/filter component 504. Each of these components will be described in greater detail infra.

As shown in FIG. 5, the connection interface component 104 can include a social interaction service component 502 and a find/filter component 504. Although the social interaction service component 502 is shown inclusive of the connection interface component 104, it is to be understood that this component 502 (as well as other components illustrated) can be located external and/or remote from the connection interface component 104 (and communication system 102) in alternative aspects.

In one particular aspect, the social interaction service component 502 can be representative of a social networking or mobile dating service where members/candidates can enter a profile of themselves and/or browse profiles of other members/candidates. Although a mobile dating service is described herein, it is to be understood that the features, functions and benefits of the innovation (e.g., messaging and notification) can be employed in other scenarios where an application or service is used to notify and/or effect communication between individuals.

As well, it is to be appreciated that the innovation contemplates and discloses an ability to provide simultaneous data and voice paths. For instance, the innovation can be used in a scenario where a user employs a PC and a phone simultaneously. In a particular aspect, the innovation can be employed when the PC is used for video communication and a landline phone is used for synchronized voice communication. Those skilled in the art will be able to appreciate other aspects that can utilize the novel functionality described herein. As such, these additional aspects are to be included within the scope of this innovation and claims appended hereto.

As well, it will be understood that the primary features of the innovation, notification and messaging, can be practiced independently of one another. By way of example, the innovation can be employed to notify users of a ‘crush’ without actually commencing or enabling message communication capabilities.

The connection interface component 104 can also include a find/filter component 504 which enables a user to define rules, preferences and/or policies associated with most all functionalities of the connection interface component 104 and the communication management component 106. For instance, a user can select parameters that define which candidates to search/query profiles based upon gender, age, geographic location, among others. Similarly, the find/filter component 504 enables a user to define other settings such as notification protocol preferences, messaging protocol preferences, acceptable time windows to receive notifications, acceptable devices, email addresses, phone numbers, etc. to receive notifications and/or messages. Essentially, most any conceivable parameter associated with the specifics (e.g., delivery) of notifications and messages can be employed without departing from the spirit and/or scope of the innovation.

Still further, in the example aspect, the find/filter component 504 can enable a user to locate users that have a particular interest in them (e.g., who crushed me). Additionally, a user can view new candidates to the service, top rated candidates, most sent candidates, etc. to further enhance social interaction services. Moreover, a user is able to search or query candidates based upon mutual, popular, new or free-format defined tags as desired.

Still further, the find/filter component 504 enables users to view their history of both crushes or flushes. In other words, a user can view other users who are interested in them as well as those users who did not express interest (e.g., crush) after being presented with a user's profile. Effectively, the find/filter component 504 enables a user to personalize their social networking experience by employing and/or defining filters, queries, rules, preferences, policies, etc.

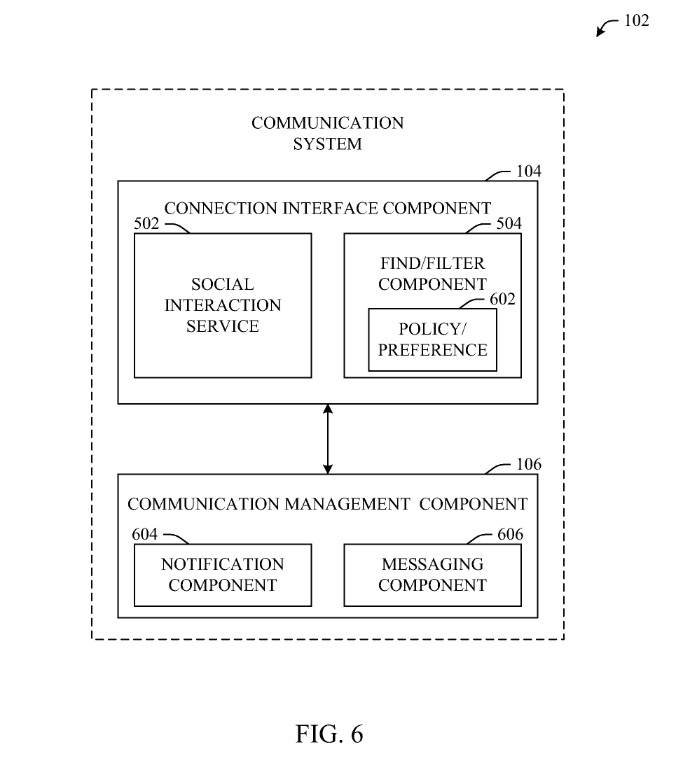

FIG. 6 illustrates yet another example block diagram of communication system 102. As shown, and as described above, the find/filter component 504 can include a policy/preference (e.g., rules logic) which can be employed to manage a user's social networking experience. As will be shown upon a review of the figures that follow, graphical user interfaces (GUIs) can be provided which enable users to utilize the functionality of the find/filter component 504.

Communication management component 106 can include a notification component 604 and a messaging component 606 in aspects. As stated above, it is to be understood that the functionality of these components (604, 606) is exclusive of each other. In other words, it is to be understood that the features, functions and/or benefits of these sub-components need not be used exclusively in conjunction with the other.

The notification component 604 can be used to set specifics related to alerts. For example, as described above, alerts can be sent to notify a user of pending or new messages, crushes, features, or the like. The delivery of these alerts can be managed by the notification component 604 in accordance with preset rules, preferences and/or policies. Additionally, MLR logic mechanisms can be employed to automatically determine parameters associated with delivery, format, etc. of alerts. Additionally, notifications can be sent to remind a user of a schedule chat, whether it be voice chat, IM chat, SMS chat, video chat or the like.

In still other aspects, when a user has a message waiting, the notification component 604 can automatically generate an alert to inform the user of the message. This alert can be timed as desired in disparate aspects. In one particular aspect, if messages are received between system logins, an alert can be sent between logins thus, a user will receive a single message regardless of how many messages were received. The alert can define when the messages were received, how many were received, the senders of the messages, etc.

As well, logic can be used to limit the number of alerts, for example, one alert between logins in one embodiment. Still further, the system can limit the number of consecutive alerts with respect to the same information. In other words, if a message is sent to a user for three (or other specified number) days, the alert can be cancelled thereafter—thus, so as to not annoy the user with regard to new messages.

The messaging component 606 can be employed to manage delivery and format of messages within the communication system 102. For example, the messaging component 606 can determine, based upon predefined rules, preferences and policies, when and how to deliver messages within the system 102. By way of specific example, messages can be sent via a specific protocol (e.g., IM, text message, picture message, email, audio, visual, etc.).

Still further, the messaging component 606 can automatically filter, order or otherwise configure messages as desired. In one aspect, messages can be sorted upon receipt date thereby showing the most recent messages at the top of a list and the later messages at the bottom (or vice-versa). Additionally, the list can identify when the messages were received (e.g., 6 days ago). This designation can be dynamic and therefore can change as time elapses. Other designations, including but not limited to, ‘New,’ ‘Recent,’ ‘Old,’ etc. can be used to further configure a list of messages. Additionally, criteria and parameters such as, but not limited to, thumbnail inclusion, thumbnail size, colors, text, etc. can be managed by the notification and messaging components 604, 606 respectively.

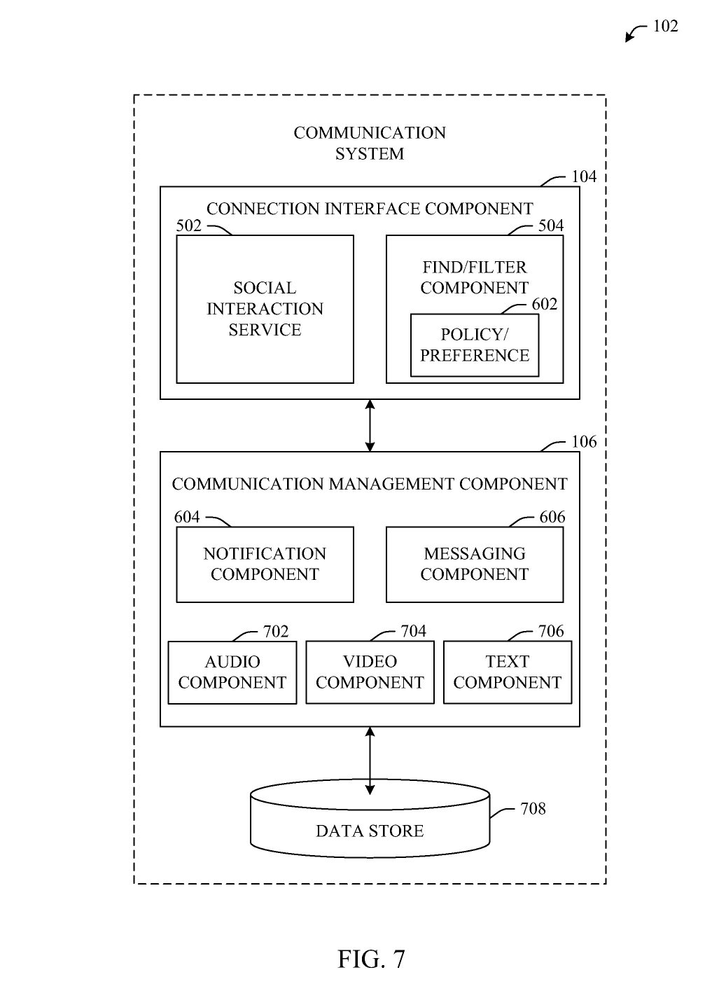

Turning now to FIG. 7, an alternative block diagram of a communication component 102 is illustrated in accordance with an aspect of the innovation. More particularly, the communication management component 106 shown in FIG. 7 includes an audio component 702, a video component 704 and a text component 706. As can be understood by the name of each component, these sub-components (702, 704, 706) of the communication management component 106 can facilitate audio, video and text notification and messaging respectively.

A data store 708 can be provided within (or external from) the communication system 102. In operation, when notifications and/or messages are sent or received, voice-mails, video mails, picture messages, or text messages can be sent for listening, viewing or reading. In aspects, the messages can be linked to the username of the caller or target, email address of either party, IM alias of either party, etc.

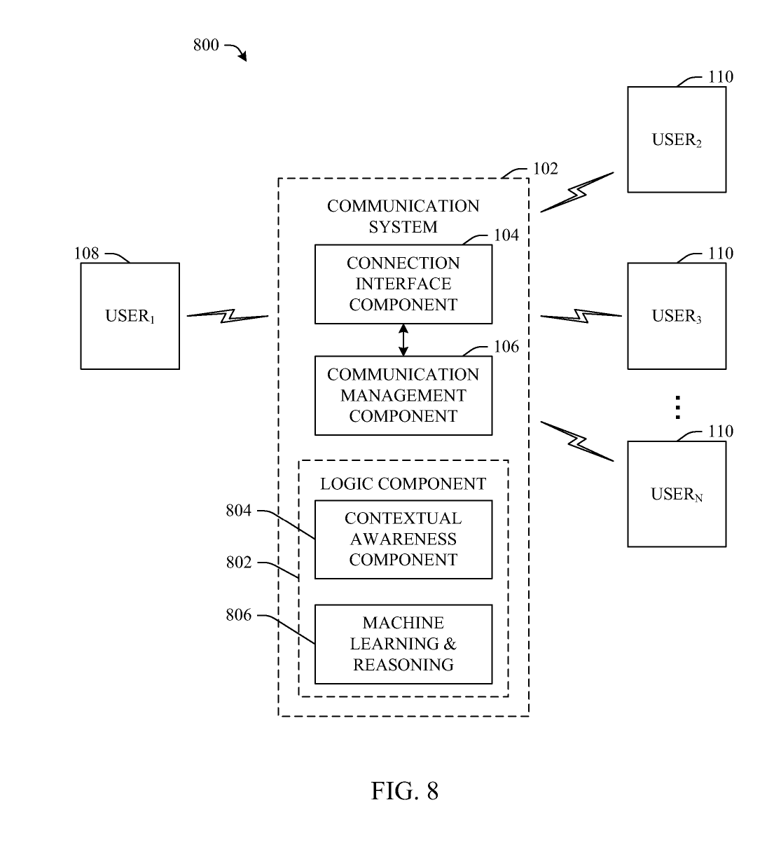

Referring now to FIG. 8, an alternative system 800 in accordance with an aspect of the innovation is shown. Generally, system 800 can include a communication system 102 that regulates notifications and messages to users (e.g., 108, 110) as described herein. More particularly, the communication system 102 can include a connection interface component 104 and a communication management component 106 (together with subcomponents) as described above. Still further, a logic component 802 having a contextual awareness component 804 and/or a MLR component 806 is provided. This logic component 802 (and optional subcomponents 804, 806) can provide for sophisticated decision-making capabilities of the communication system 102 generally.

In particular, the contextual awareness component 804 can be employed to consider most any contextual factor when generating, prompting and/or delivering notifications (e.g., alerts) and/or messages. In examples, location, time of day, day of week, etc. can be factored into decisions related to notifications and/or messages. Still further, factors such as engaged activity, calendar appointments (schedule), tasks, individuals in proximity, upcoming activities, or the like can be factored into decision logic related to notifications and/or messages.

By way of specific example, the logic component 802 can access a user's personal information manager (PIM) data in order to establish a current activity of a user. For instance, if the PIM data indicates that a user is in a meeting, the communication management component 106 can postpone notification or message delivery. Alternatively, this information can be used to determine a protocol and/or target user device with respect to notifications and/or messages. While specific examples are given, it is to be understood most any contextual factor can be considered in the functionality of the communication system 102.

Still further, MLR logic 806 can be employed to automate one or more functions of the communication system 102. For instance, the innovation can employ MLR mechanisms which facilitate automating one or more features in accordance with the subject innovation. The subject innovation (e.g., in connection with selection of protocol, device, etc.) can employ various MLR-based schemes for carrying out various aspects thereof. For example, a process for determining protocol selection, delivery timing, delivery device, etc. related to notification/messaging can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to deliver a notification/message, how to deliver the notification/message, where to deliver the notification/message, etc.

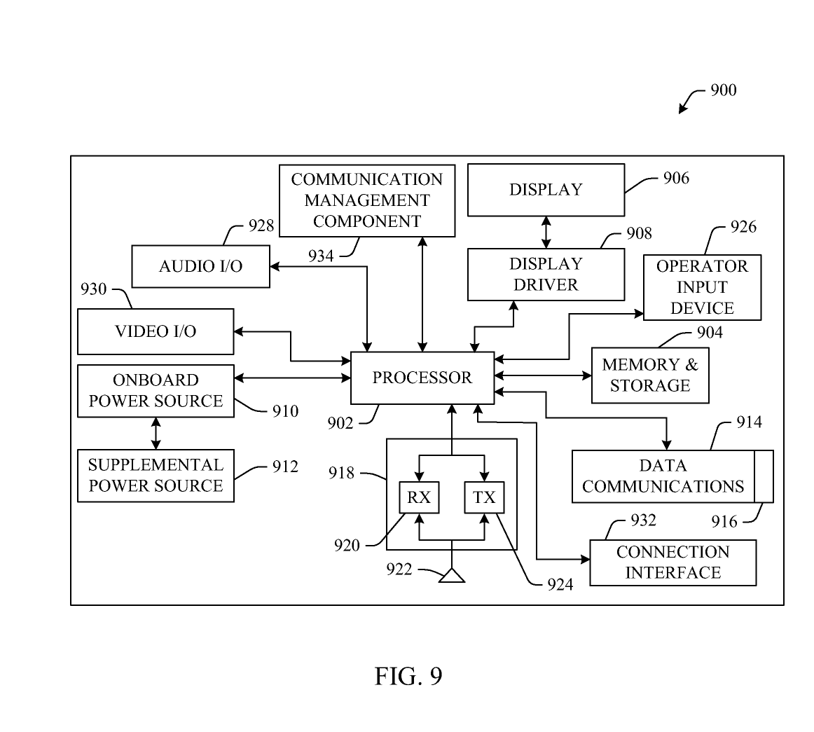

Referring now to FIG. 9, there is illustrated a schematic block diagram of a portable hand-held device 900 according to one aspect of the subject invention, in which a processor 902 is responsible for controlling the general operation of the device 900. The processor 902 can be programmed to control and operate the various components within the device 900 in order to carry out the various novel functions described herein. The processor 902 can be any of a plurality of suitable processors. The manner in which the processor 902 can be programmed to carry out the functions relating to the subject innovation will be readily apparent to those having ordinary skill in the art based on the description provided herein. As described in greater detail supra, contextual awareness and/or MLR components can be used to effect an automatic action (and sophisticated decision-making) of processor 902.

A memory and storage component 904 connected to the processor 902 serves to store program code executed by the processor 902, and also serves as a storage means for maintaining information such as data, services, metadata, device states, electronic mail messages, or the like. The memory 904 can be a non-volatile memory suitably adapted to store at least a complete set of the information that is acquired. Thus, the memory 904 can include a RAM or flash memory for high-speed access by the processor 902 and/or a mass storage memory, e.g., a micro drive capable of storing gigabytes of data that comprises text, images, audio, and video content. According to one aspect, the memory 904 has sufficient storage capacity to store multiple sets of information relating to disparate services, and the processor 902 could include a program for alternating or cycling between various sets of information corresponding to disparate services.

A display 906 can be coupled to the processor 902 via a display driver system 908. The display 906 can be a color liquid crystal display (LCD), plasma display, touch screen display or the like. In one example, the display 906 is a touch screen display. The display 906 functions to present data, graphics, or other information content via a UI. Additionally, the display 906 can display a variety of functions that control the execution of the device 900. For example, in a touch screen example, the display 906 can display touch selection buttons. In operation, when the notifications and/or messages are delivered, the UI, via display 906, can effectively convey the notifications and/or messages to a user. As described above, these notifications and/or messages can be text, visual, audio or combinations thereof.

Power can be provided to the processor 902 and other components forming the hand-held device 900 by an onboard power system 910 (e.g., a battery pack). In the event that the power system 910 fails or becomes disconnected from the device 900, a supplemental power source 912 can be employed to provide power to the processor 902 (and other components (e.g., image capture device)) and to charge the onboard power system 910. The processor 902 of the device 900 can induce a sleep mode to reduce the current draw upon detection of an anticipated power failure.

The device 900 includes a communication subsystem 914 having a data communication port 916, which is employed to interface the processor 902 with a remote computer, server, service, or the like. The port 916 can include at least one of Universal Serial Bus (USB) and IEEE 1394 serial communications capabilities. Other technologies can also be included, but are not limited to, for example, infrared communication utilizing an infrared data port, Bluetooth™, wireless protocols, etc.

The device 900 can also include a transceiver section 918 in operative communication with the processor 902. The transceiver section 918 includes a receiver 920, which receives signals from a remote device via an antenna 922 and can process the signal to obtain digital information therein. The transceiver section 918 also includes a transmitter 924 for transmitting information (e.g., data, service) to a remote device, for example, in response to manual user input via a operator input 926 (e.g., a keypad).

The transceiver section 918 facilitates communication with other portable devices and/or host computer systems. In furtherance thereof, an audio I/O section 928 is provided as controlled by the processor 902 to process voice input from a microphone (or similar audio input device) and can transmit audio output signals (from a speaker or similar audio output device).

In another implementation, the device 900 can provide speech recognition capabilities such that when the device 900 is used as a voice activated device, the processor 902 can facilitate high-speed conversion of the voice signals into text or operative commands. For example, the converted voice signals can be used to control the device 900 in lieu of using manual entry via the keypad 926. As well, in another aspect, voice commands can be employed to effect coupling and/or decoupling from a remote system. Still further, voice activated commands can be employed to ‘crush’ (select) or ‘flush’ (pass) with regard to presented candidates. Most any appropriate functionality of the innovation can be controlled via voice commands.

Similarly, video signals can be input and/or output via the video I/O component 930. The video I/O component 930 can include an image capture device capable of providing video communications via the mobile device 900.

Other components such as a connection interface 932 and communication management component 934 can be provided within the housing of the device 900 to effectuate functionality described supra. For example, the connection interface 932 can be employed in connection with setting parameters by way of a find/filter component 504. As well, the communication management component 934 can be employed to manage generation and/or deliver of notifications and/or messages.

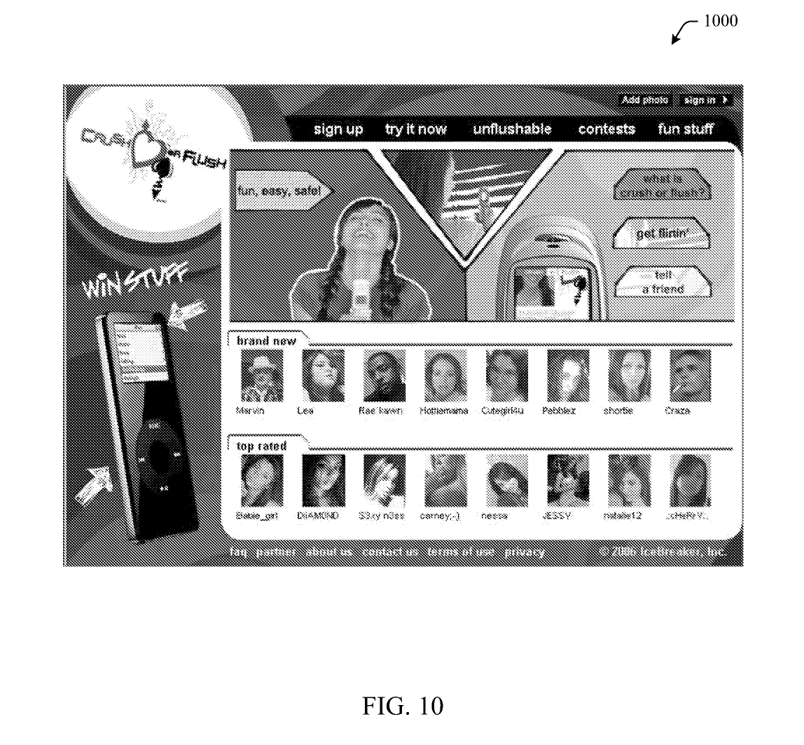

FIGS. 10-23 illustrate example GUI screen shots in accordance with aspects of the components and sub-components described supra. Essentially, the figures depict example interfaces that illustrate features, functions and benefits described above. It is to be appreciated that these example GUIs are provided to add perspective to the innovation and are not intended to limit the scope of the innovation in any way.

Referring initially to FIG. 10, an example ‘home’ screen 1000 is illustrated. Among other features, the GUI 1000 enables users to Sign In by making the proper selection in the upper right hand corner of the screen. Moreover, ‘Brand New’ and ‘Top Rated’ members can be shown. In other aspects, the ‘home’ screen 1000 can be configured based upon personalized information and settings, for example, settings set within the find/filter component 504 described above. Rather than displaying the same home screen to all users, an alternative embodiment can employ a personalized home screen based upon criteria, policies, preferences, etc. of a user. Cookies or other suitable tracking mechanisms can be employed to automatically load this information to effect home screen personalization.

Once a user signs in, or selects ‘try it now’ from the ‘home’ screen, they can thereafter browse candidates (members). Here, a user can decide to ‘crush’ or ‘flush’ each individual candidate based upon any desired criteria, including but, not limited to appearance, tags, age, location, etc.

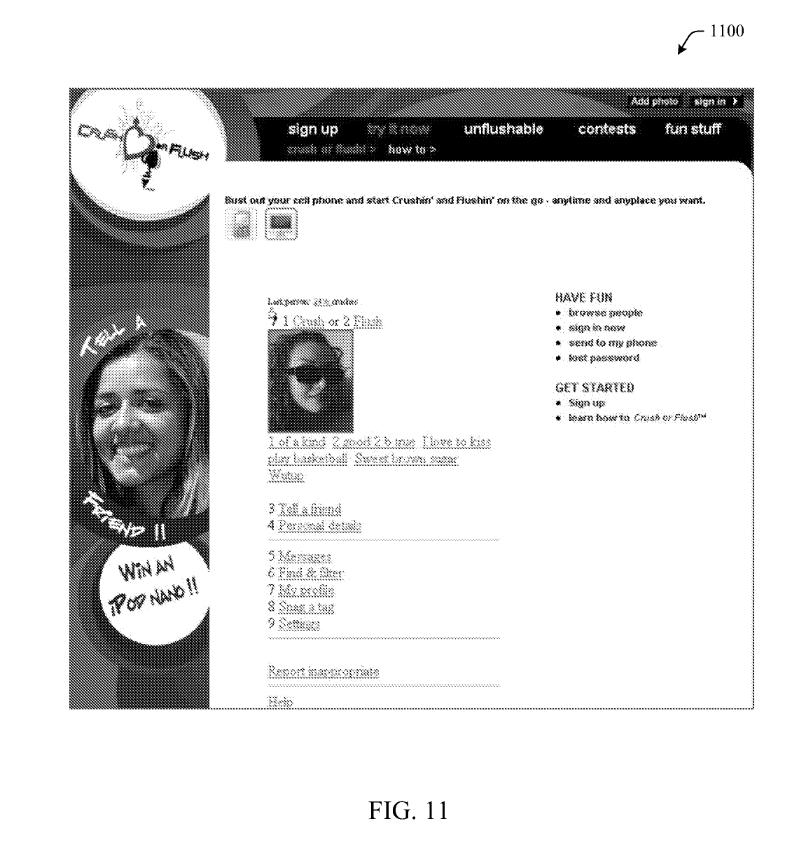

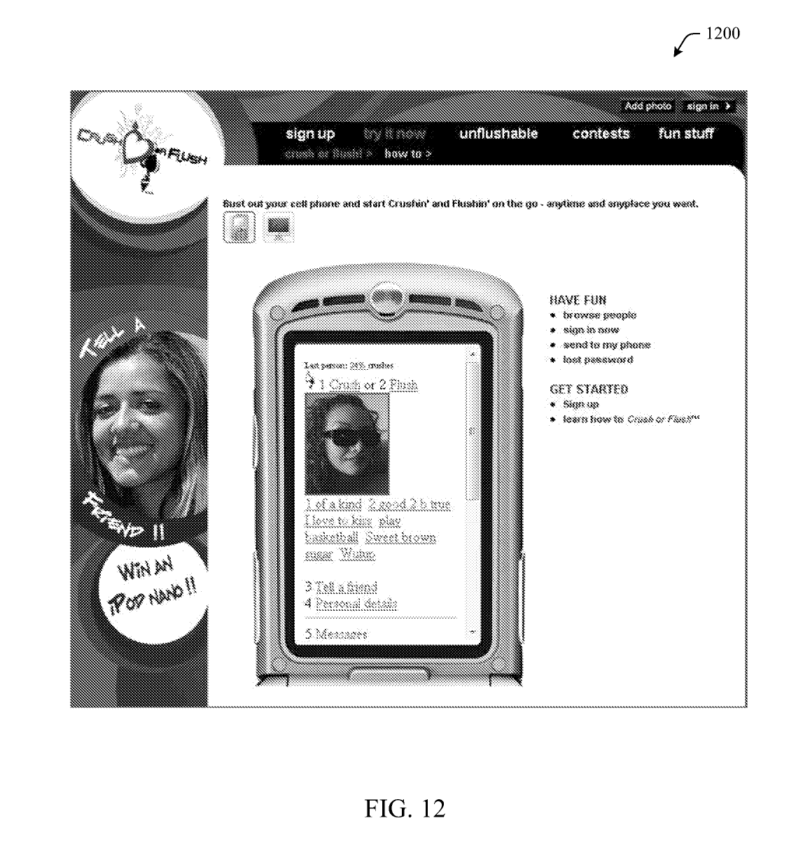

FIG. 11 illustrates a screen shot of a GUI 1100 in accordance with an aspect of the innovation. As can be determined, FIG. 11 illustrates a GUI 1100 which does not use a personalized skin. Alternatively, FIG. 12 illustrates a comparable GUI 1200 using a skin of a cell phone. It is to be understood that the GUI 1200 illustrates what the application would appear as if it were employed by way of a cell phone. It is to be understood that the example of FIG. 12 is but one example of countless skins and devices that can be employed in accordance with the innovation. As such, these countless embodiments are to be included within the scope of the innovation and claims appended hereto.

Referring again to FIG. 11, the screen shows an example of the profile browsing capability of the innovation. As described above, options 1 and 2 enable the ‘crush’ or ‘flush’ selections in accordance with this aspect. Options 3 and 4 enable ‘Tell a friend’ and ‘Personal details’ respectively. ‘Tell a friend’ enables a user to pass along a candidates profile to a friend. ‘Personal details’ expands the profile to include candidate-inputted details.

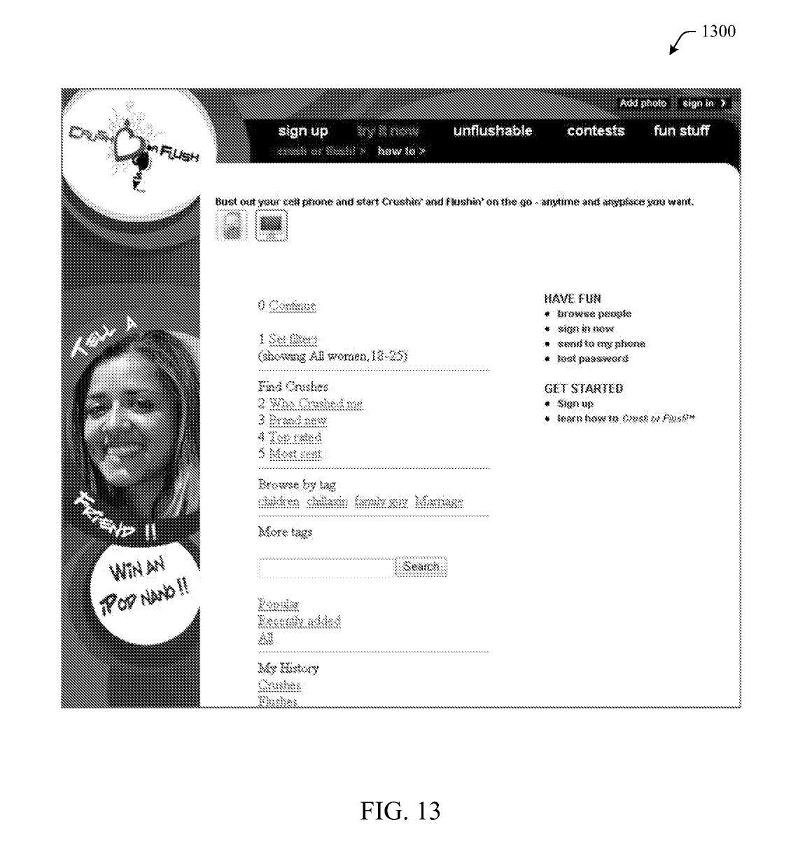

Option 5 prompts the system to display messages. Here, as described above, the messages can be sorted, ranked, ordered or configured in most any desired manner. This messages display will be described in more detail in the figures that follow. Option 6 prompts functionality of the find/filter component 504 described above. Options included within the example find/filter GUI will be shown and described with reference to FIG. 13 that follows.

As shown in FIG. 13, an example GUI 1300 is illustrated in accordance with the innovation. In particular, GUI 1300 illustrates five example options related to the find/filter functionality. Option 1 enables a user to set filters, where the filters are used to sort candidates within the browse profile GUI (e.g., 1100, 1200). As shown in FIG. 13, the filter is currently set to display “All women, 18-25.” In other words, the system will only display female candidates between the ages of 18 and 25 years of age.

Upon selecting Option 1, a user can drill down filters and further establish criteria by which candidates are filtered. For example, a user can further sort candidates based upon location, tags, etc. It is to be understood that most any criteria can be used to filter candidates in accordance with embodiments of the innovation. In other words, so long as the information is available, a filter can be configured to consider thresholds, strings, ranges, etc. as desired.

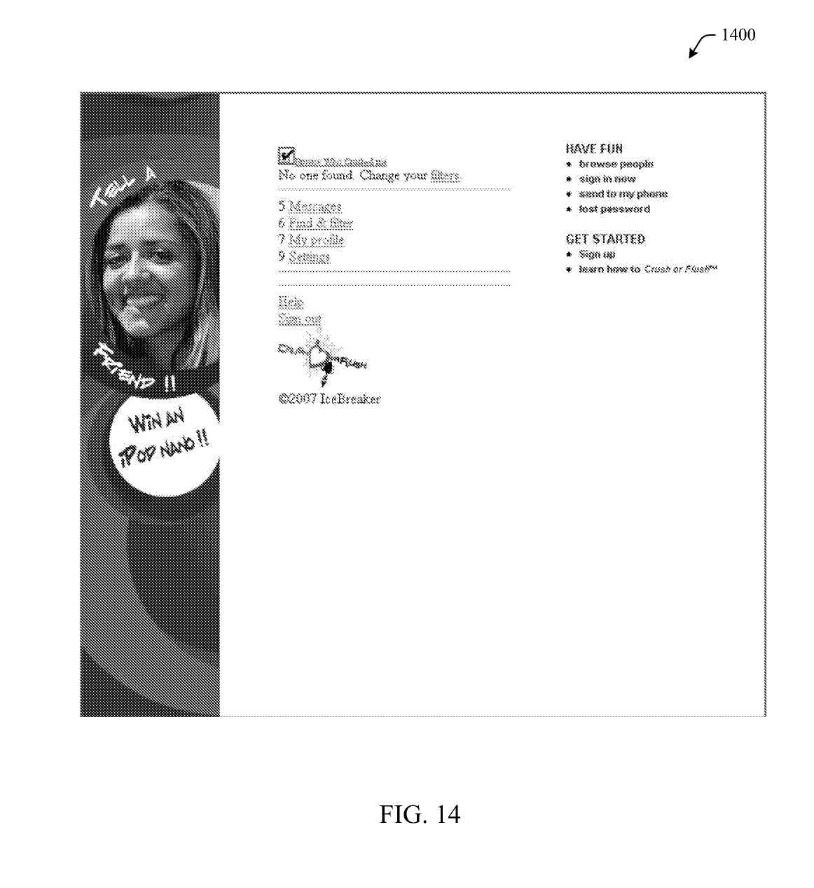

Option 2 can be used to show “Who Crushed me.” Here, the system can notify a user of who crushed them. Similarly, a percentage of crushes can be conveyed within an example GUI. FIGS. 14-16 illustrate this functionality with regard to “Who Crushed me.”

Referring first to FIG. 14, an example GUI 1400 of “Who Crushed me” is shown. Specifically, the GUI 1400 is provided to illustrate the interactivity between the notifications and the filters. Here, there are no crushes illustrated. Rather, as shown, the system prompts the user to “Change your filters.” In other words, there were no crushes by women between the ages of 18 and 25 years of age.

It is important to note that the system notifies the user of the particular GUI—for example, by identifying “Browse Who Crushed me” on the top of the screen. Additionally, the GUI 1400 provides links to make resetting filters easy and efficient.

Once the filters are modified, GUI 1500 illustrates crushes within the newly specified ranges (e.g., age, gender, location, etc.). As can be seen, the GUI 1500 identifies that a particular candidate “Has a Crush on you!” Again, it is interesting to note the notification atop the screen that identifies the particular significance, e.g., =Browse Who Crushed me.” As well, a notification is given that identifies how many (or what percentage of) crushes a user received. Similarly, flushes can be conveyed in a similar manner. Still further, it is to be understood that, when a user visits his/her home profile page, a notification can be provided similar to that shown in GUI 1500 whereby the number of (or percentage of) crushes and/or flushes is conveyed.

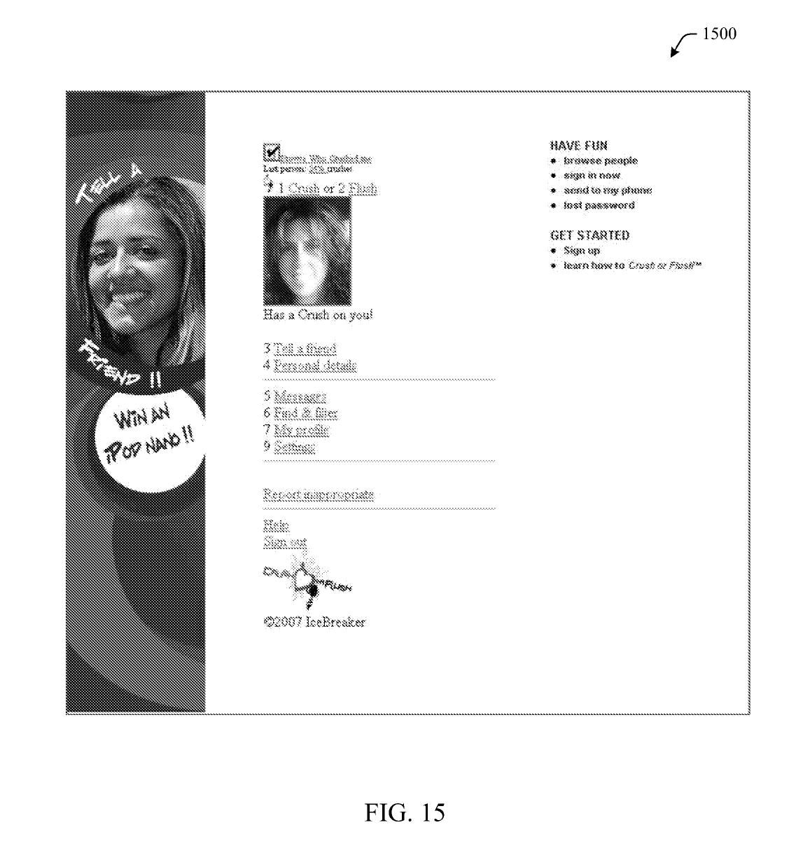

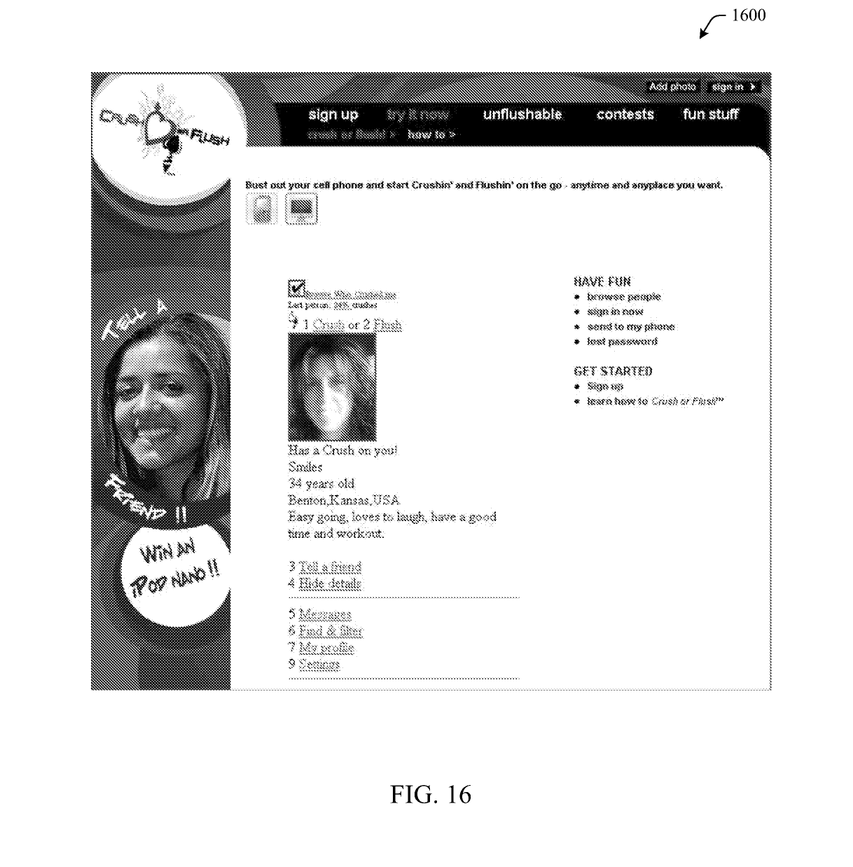

FIG. 16 illustrates a GUI 1600 similar to that of FIG. 15. As shown, the GUI 1600 displays the details of a particular crush. It should be noted that this particular crush is 34 years old, not within the original range of 18 to 25 years of age as in the example. Still further, it is to be understood that by selecting Option 1, a user will prompt a ‘mutual crush’ thereby enabling mutual communication (e.g., via messaging component).

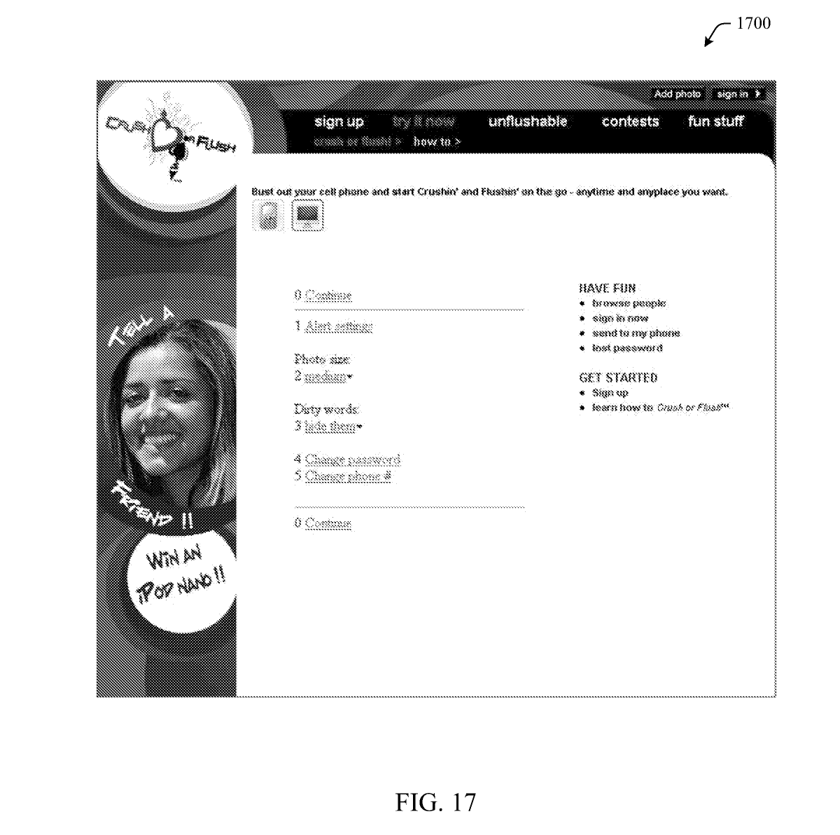

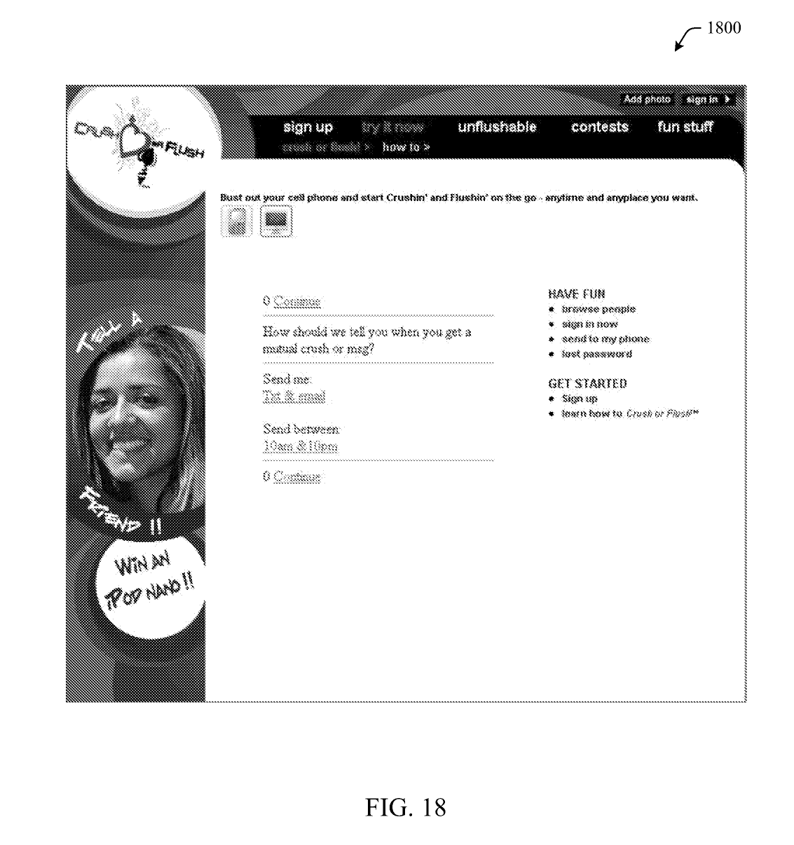

Turning now to FIG. 17, an example GUI 1700 that facilitates modifying settings in accordance with aspects of the innovation is shown. In particular, in this example, Option 1 enables a user to define alert settings. These alert settings define policies and/or preferences related to notifications and/or alerts. A specific GUI related to alert settings is shown in FIG. 18.

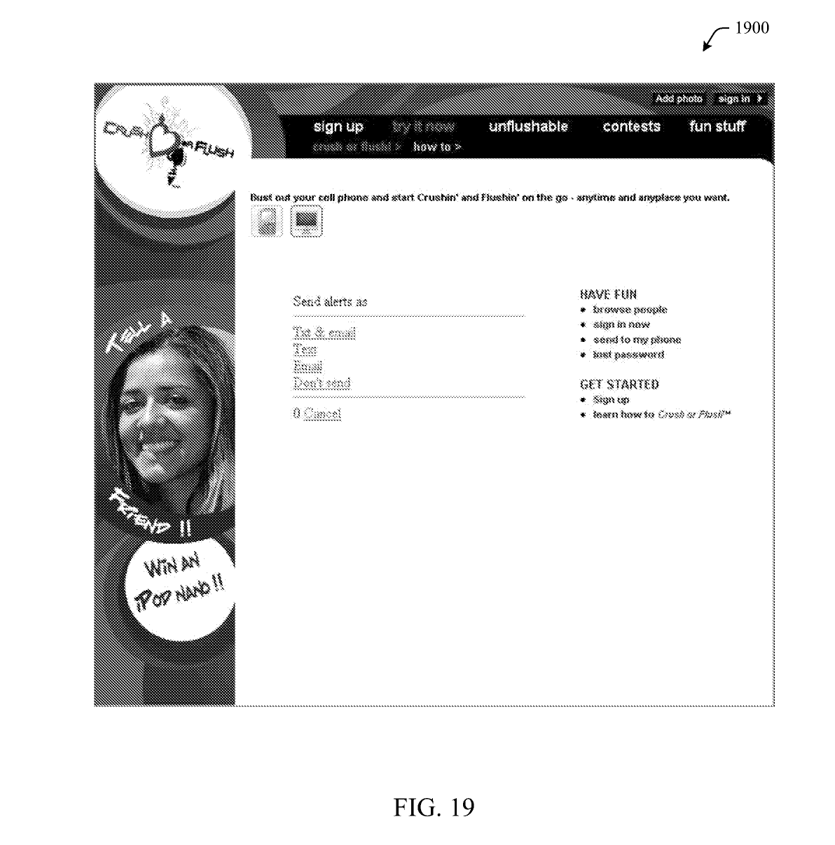

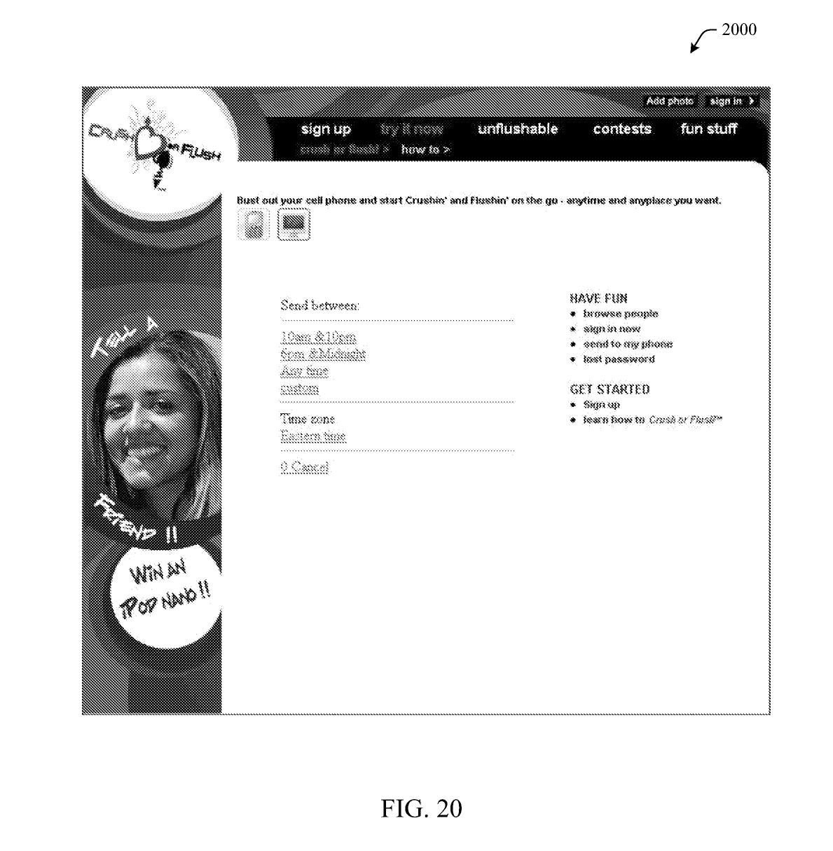

Turning to FIG. 18, an example GUI 1800 that enables definition of alerts in accordance with aspects of the innovation are shown. In the example GUI 1800, as shown, definitions can be set to identify protocols to employ for delivery of alerts. Similarly, a time range can be defined. FIGS. 19 and 20 illustrate example GUIs (1900, 2000) that facilitate setting protocol and time ranges respectively.

Referring first to FIG. 19, a GUI 1900 that facilitates selection of a modality (or protocol) by which to deliver alerts is shown. In particular, a selection can be made to send “Txt & email,” “Text,” “Email,” or alternatively, “Don't send.” While this example includes specific modalities, text message and email, it is to be understood that most any modality can be included without departing from the spirit and scope of the innovation. For example, other modalities such as IM, voice call, audible, or the like can be employed without departing from the spirit and/or scope of the innovation.

FIG. 20 illustrates another example GUI 2000 in accordance with an aspect of the innovation. In accordance with this GUI 2000, a user can define time ranges by which alerts or notifications can be sent (or, alternatively, should not be sent). As described above, alerts that identify recent crushes, new messages, or the like can be controlled in accordance with policies and/or preferences. As shown, most any time range can be selected in accordance with the innovation. It is to be understood that this example is but one example of a selection menu. In other words, other examples exist which are to be included within the scope of the innovation. For instance, multiple time ranges can selected in alternative aspects without departing from the spirit and/or scope of the innovation.

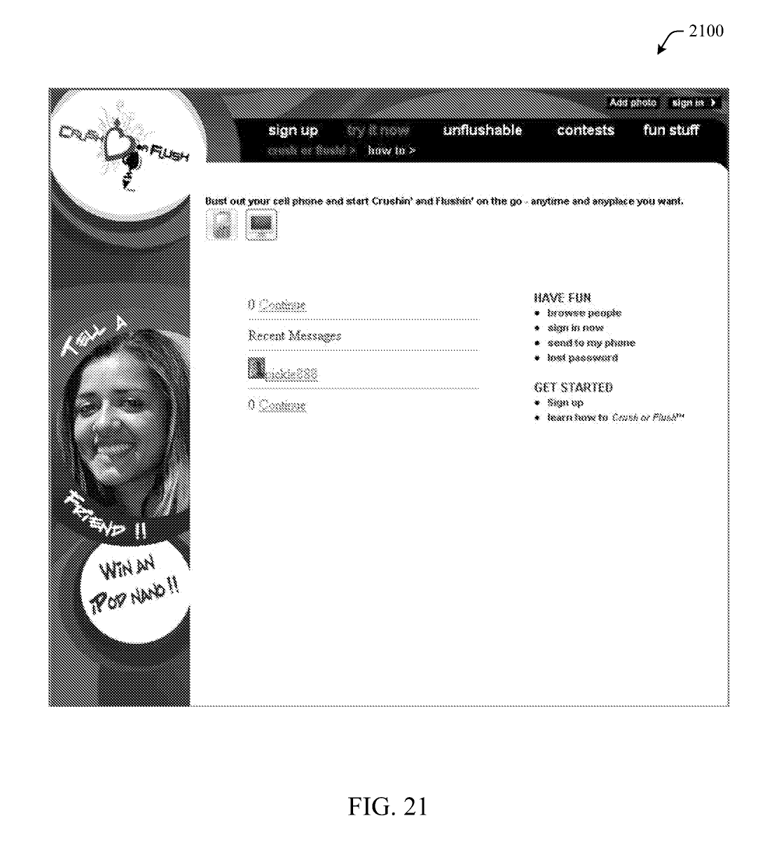

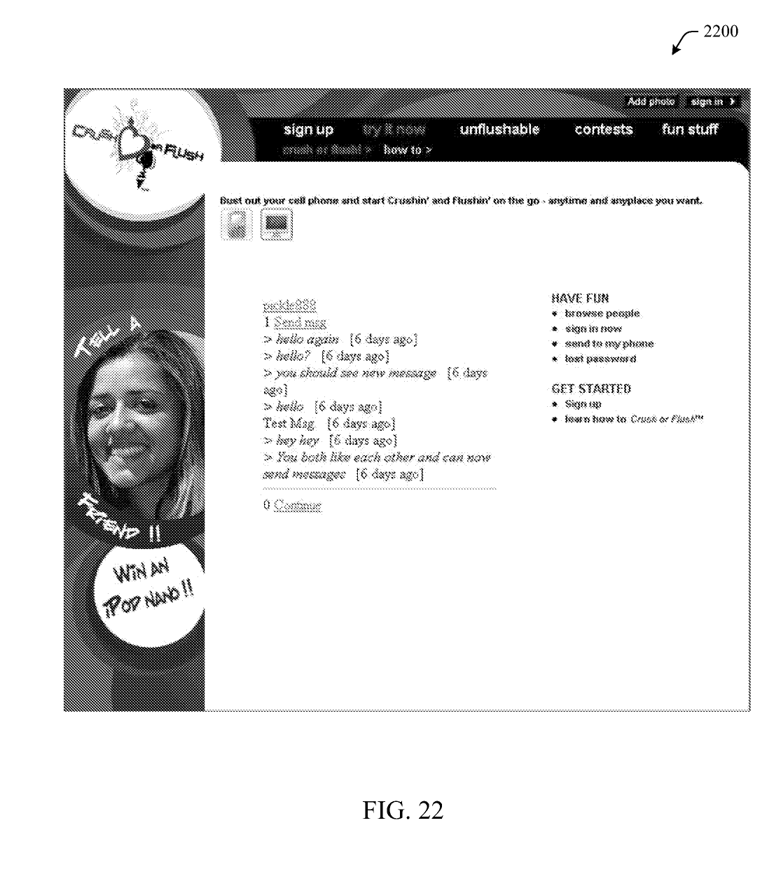

While much of the discussion above has been directed to notification and alert settings, FIG. 21 illustrates an example GUI 2100 that illustrates a message list in accordance with the innovation. Here, messages can be ranked, ordered, or configured as desired. In this example, recent messages from “pickle888” are illustrated as the most recent messages. A sample ordering of the messages can be seen with reference to FIG. 22.

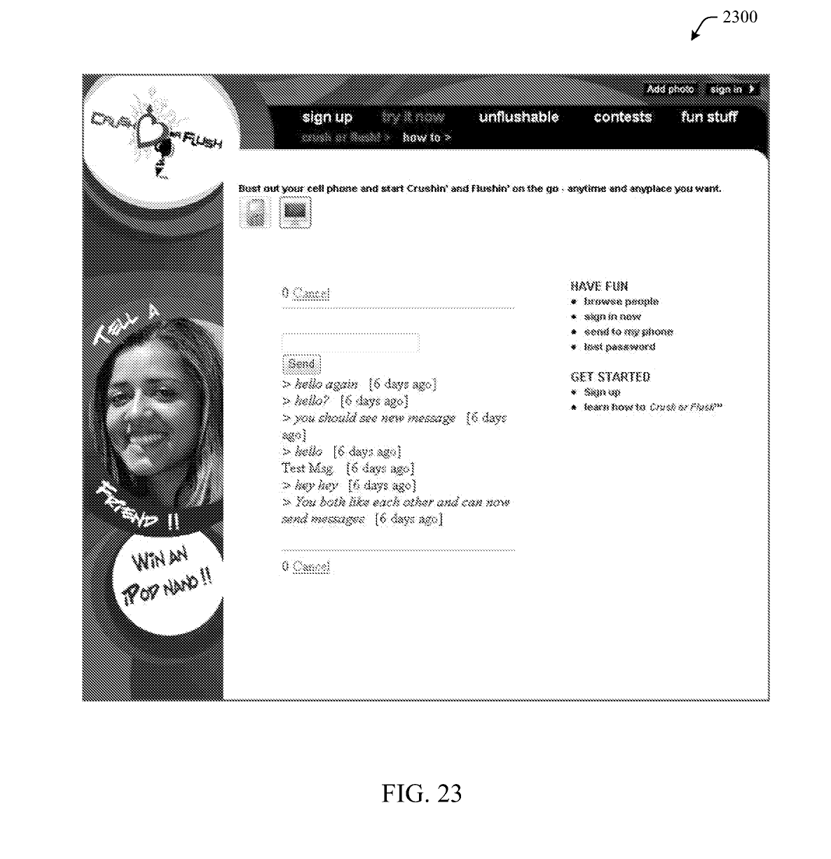

In the example of FIG. 22, as can be seen, the messages are tagged as being received “6 days ago.” Here, if there were more recent or older messages, these messages would be reflected within the listing of FIGS. 21 and 22. Additionally, as shown, GUI 2200 enables a user to respond or “Send msg” to the sender of current messages, here “pickle888.” This functionality is illustrated in FIG. 23. As shown, a text box is displayed whereby a user can enter a text message to be sent to a user.

Still further, it is to be understood that alternative aspects can enable voice and/or video messages to be sent to a mutual crush. In one example, a visual message can be made using a webcam or other suitable device. As will, communication can occur in real-time in other aspects. Still further, messages can be pre-recorded and uploaded as desired.

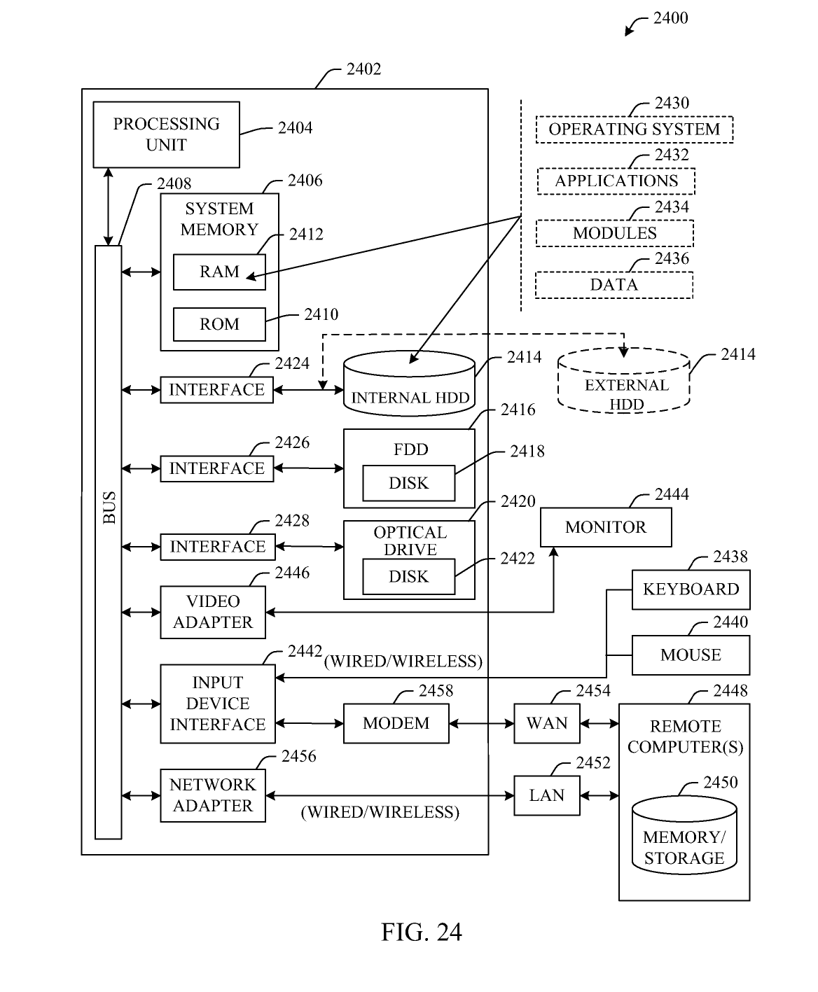

Referring now to FIG. 24, there is illustrated a block diagram of a computer operable to execute the disclosed architecture. In order to provide additional context for various aspects of the subject innovation, FIG. 24 and the following discussion are intended to provide a brief, general description of a suitable computing environment 2400 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 24, the example environment 2400 for implementing various aspects of the innovation includes a computer 2402, the computer 2402 including a processing unit 2404, a system memory 2406 and a system bus 2408. The system bus 2408 couples system components including, but not limited to, the system memory 2406 to the processing unit 2404. The processing unit 2404 can be any of various commercially available processors. Dual microprocessors and other multi-processor architectures may also be employed as the processing unit 2404.

The system bus 2408 can be any of several types of bus structure that may further interconnect to a memory bus (with or without a memory controller), a peripheral bus, and a local bus using any of a variety of commercially available bus architectures. The system memory 2406 includes read-only memory (ROM) 2410 and random access memory (RAM) 2412. A basic input/output system (BIOS) is stored in a non-volatile memory 2410 such as ROM, EPROM, EEPROM, which BIOS contains the basic routines that help to transfer information between elements within the computer 2402, such as during start-up. The RAM 2412 can also include a high-speed RAM such as static RAM for caching data.

The computer 2402 further includes an internal hard disk drive (HDD) 2414 (e.g., EIDE, SATA), which internal hard disk drive 2414 may also be configured for external use in a suitable chassis (not shown), a magnetic floppy disk drive (FDD) 2416, (e.g., to read from or write to a removable diskette 2418) and an optical disk drive 2420, (e.g., reading a CD-ROM disk 2422 or, to read from or write to other high capacity optical media such as the DVD). The hard disk drive 2414, magnetic disk drive 2416 and optical disk drive 2420 can be connected to the system bus 2408 by a hard disk drive interface 2424, a magnetic disk drive interface 2426 and an optical drive interface 2428, respectively. The interface 2424 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 2402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the innovation.

A number of program modules can be stored in the drives and RAM 2412, including an operating system 2430, one or more application programs 2432, other program modules 2434 and program data 2436. All or portions of the operating system, applications, modules, and/or data can also be cached in the RAM 2412. It is appreciated that the innovation can be implemented with various commercially available operating systems or combinations of operating systems.

A user can enter commands and information into the computer 2402 through one or more wired/wireless input devices, e.g., a keyboard 2438 and a pointing device, such as a mouse 2440. Other input devices (not shown) may include a microphone, an IR remote control, a joystick, a game pad, a stylus pen, touch screen, or the like. These and other input devices are often connected to the processing unit 2404 through an input device interface 2442 that is coupled to the system bus 2408, but can be connected by other interfaces, such as a parallel port, an IEEE 1394 serial port, a game port, a USB port, an IR interface, etc.

A monitor 2444 or other type of display device is also connected to the system bus 2408 via an interface, such as a video adapter 2446. In addition to the monitor 2444, a computer typically includes other peripheral output devices (not shown), such as speakers, printers, etc.

The computer 2402 may operate in a networked environment using logical connections via wired and/or wireless communications to one or more remote computers, such as a remote computer(s) 2448. The remote computer(s) 2448 can be a workstation, a server computer, a router, a personal computer, portable computer, microprocessor-based entertainment appliance, a peer device or other common network node, and typically includes many or all of the elements described relative to the computer 2402, although, for purposes of brevity, only a memory/storage device 2450 is illustrated. The logical connections depicted include wired/wireless connectivity to a local area network (LAN) 2452 and/or larger networks, e.g., a wide area network (WAN) 2454. Such LAN and WAN networking environments are commonplace in offices and companies, and facilitate enterprise-wide computer networks, such as intranets, all of which may connect to a global communications network, e.g., the Internet.

When used in a LAN networking environment, the computer 2402 is connected to the local network 2452 through a wired and/or wireless communication network interface or adapter 2456. The adapter 2456 may facilitate wired or wireless communication to the LAN 2452, which may also include a wireless access point disposed thereon for communicating with the wireless adapter 2456.

When used in a WAN networking environment, the computer 2402 can include a modem 2458, or is connected to a communications server on the WAN 2454, or has other means for establishing communications over the WAN 2454, such as by way of the Internet. The modem 2458, which can be internal or external and a wired or wireless device, is connected to the system bus 2408 via the serial port interface 2442. In a networked environment, program modules depicted relative to the computer 2402, or portions thereof, can be stored in the remote memory/storage device 2450. It will be appreciated that the network connections shown are example and other means of establishing a communications link between the computers can be used.

The computer 2402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

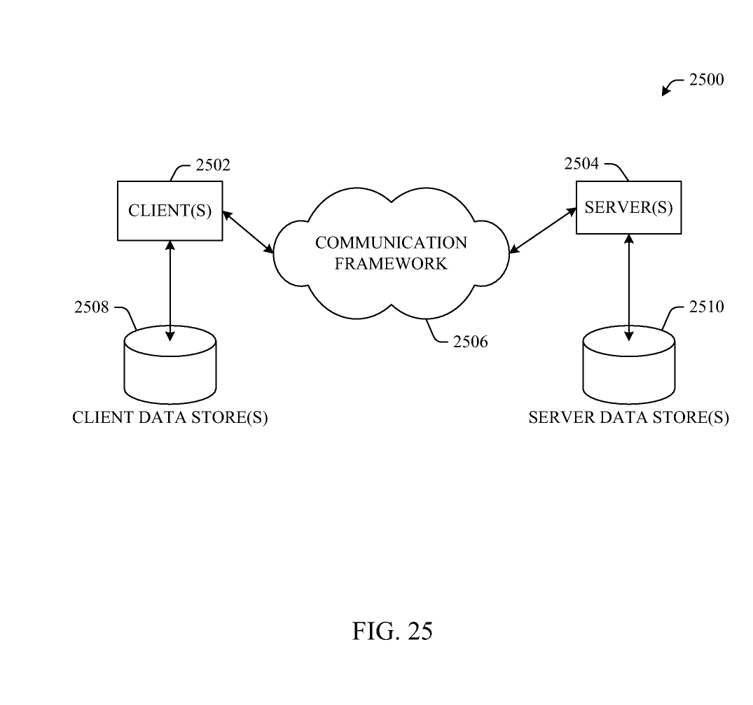

Referring now to FIG. 25, there is illustrated a schematic block diagram of an example computing environment 2500 in accordance with the subject innovation. The system 2500 includes one or more client(s) 2502. The client(s) 2502 can be hardware and/or software (e.g., threads, processes, computing devices). The client(s) 2502 can house cookie(s) and/or associated contextual information by employing the innovation, for example.

The system 2500 also includes one or more server(s) 2504. The server(s) 2504 can also be hardware and/or software (e.g., threads, processes, computing devices). The servers 2504 can house threads to perform transformations by employing the innovation, for example. One possible communication between a client 2502 and a server 2504 can be in the form of a data packet adapted to be transmitted between two or more computer processes. The data packet may include a cookie and/or associated contextual information, for example. The system 2500 includes a communication framework 2506 (e.g., a global communication network such as the Internet) that can be employed to facilitate communications between the client(s) 2502 and the server(s) 2504.

Communications can be facilitated via a wired (including optical fiber) and/or wireless technology. The client(s) 2502 are operatively connected to one or more client data store(s) 2508 that can be employed to store information local to the client(s) 2502 (e.g., cookie(s) and/or associated contextual information). Similarly, the server(s) 2504 are operatively connected to one or more server data store(s) 2510 that can be employed to store information local to the servers 2504.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that administers communication between a user and a plurality of candidates, comprising:
a connection interface component that employs criterion to present the user with a plurality of candidates wherein the user can express interest in a subset of the plurality of candidates; and
a communication management component delivers a notification to each of the subset of the plurality of candidates as a function of the interest.

2. The system of claim 1, the criterion identifies the plurality of candidates based at least in part upon interest in the user.

3. The system of claim 1, wherein the communication management component enables contact between the user and a subset of the subset based upon a mutual interest.

4. The system of claim 3, wherein the contact is enabled via at least one of a text message, a picture message, an instant message (IM), an email, a phone call, video messaging, or a voice call.

5. The system of claim 1, wherein the notification is enabled via at least one of a text message, a picture message, an IM, an email, a phone call, video messaging, or a voice call.

6. The system of claim 1, wherein the notification is delivered as a function of user-defined criteria.

7. The system of claim 6, wherein the user-defined criteria identifies a modality for delivery of the notification.

8. The system of claim 6, wherein the user-defined criteria identifies a time range for delivery of the notification.

9. The system of claim 1, further comprising a social interaction service that enables presentation of the plurality of candidates.

10. The system of claim 9, further comprising a find/filter component that enables generation of the criterion, wherein the criterion defines a policy or preference.

11. The system of claim 10, wherein the find/filter component facilitates tracking of at least one of completed filters, recent filters, partial filters or notification windows.

12. The system of claim 1, further comprising a notification component that generates the notification as a function of the interest.

13. The system of claim 1, further comprising a messaging component that enables a plurality of messages to be sent between the user and a subset of the plurality of candidates based upon a mutual interest.

14. The system of claim 1, wherein the messaging component configures and displays the plurality of messages as a function of at least one of candidate rank, receipt order, date or time.

15. The system of claim 14, a subset of the plurality of messages are at least one of textual messages, picture messages, audio messages or video messages.

16. The system of claim 1, further comprising at least one of a contextual awareness component or a machine learning and reasoning component employs at least one of contextual, a probabilistic or a statistical-based analysis that infers an action that the user desires to be automatically performed

17. A computer-implemented method of managing communication related to a social networking service, comprising:
detecting a user interest in a candidate;
notifying the candidate of the interest based upon a policy;
prompting the candidate to express interest in the user; and
enabling message communication between the user and the candidate upon consummation of a mutual interest.

18. The computer-implemented method of claim 17, further comprising displaying a series of messages between the user and the candidate.

19. The computer-implemented method of claim 18, further comprising one of sorting, filtering, ranking, ordering or configuring the series of messages.

20. The computer-implemented method of claim 19, further comprising establishing the policy, wherein the policy defines an alerting protocol and an acceptable time frame for notification.

21. A social interaction system, comprising.
means for presenting a candidate to a user;
means for detecting interest by the user in the candidate;
means for notifying the candidate of the user interest;
means for presenting the user to the candidate;
means for detecting interest by the candidate in the user; and
means for notifying the user of the candidate interest.

22. The system of claim 21, further comprising:
means for transmitting a plurality of messages between the user and the candidate;
means for categorizing the plurality of messages; and
means for displaying the categorized plurality of messages.
